(19) United States
(12) Patent Application Publication
(10) Pub. No.: US 2007/0208844 A1
(43) Pub. Date: Sep. 6, 2007

(54) Computer Arrangement and Method for Providing Services for Clients Over a Network

(75) Inventors: Joseph W. Armstrong, Santa Cruz, CA (US); Shu-Ching Hsu, Fremont, CA (US); Mark Johnston, Campbell, CA (US); Rahul Kelkar, Fremont, CA (US); Judy King, San Luis Obispo, CA (US); Brian Kress, Brockport, NY (US); Radhika Pennepalli, Fremont, CA (US); Kesava Pulijala, Santa Clara, CA (US); Guangji Shen, San Jose, CA (US); Pushkar Singh, Fremont, CA (US); Kevin Stoner, San Jose, CA (US); Rajendran Vishwanathan, San Jose, CA (US)

Correspondence Address: EDELL, SHAPIRO & FINNAN, LLC, 1901 RESEARCH BOULEVARD, SUITE 400, ROCKVILLE, MD, 20850, US

(73) Assignee: FUJITSU SIEMENS COMPUTERS, INC., Sunnyvale, CA (US)

(21) Appl. No.: 11/685,485

(22) Filed: Mar. 13, 2007

Related U.S. Application Data
(63) Continuation of application No. PCT/EP05/09718, filed on Sep. 9, 2005.
(60) Provisional application No. 60/609,283, filed on Sep. 13, 2004.

(51) Int. Cl. G06F 15/173

(52) U.S. Cl. 709/223

(57) ABSTRACT

A computer arrangement for providing services to clients over a network includes: at least two servers, each server hosting at least one application, an automated administrator configured to automatically provision the servers to provide the services, and at least one network load balancer connected to the clients and the servers. The network load balancer is responsible for at least one of the services and is configured to gather state information on the state of the servers and/or the applications hosted on the servers and is operable to route incoming requests of clients to at least one of the servers. The network load balancer provides the automated administrator with the state information. The automated administrator provides the network load balancer with provisioning information regarding which servers are provisioned to provide the at least one service for which the network load balancer is responsible.

### CROSS REFERENCE TO RELATED APPLICATIONS

This application is a continuation of International Application No. PCT/EP2005/009718, filed on Sep. 9, 2005, entitled “Computer Arrangement and Method for Providing Services for Clients Over a Network,” which claims the benefit of U.S. Provisional Application No. 60/609,283, filed on Sep. 13, 2004, the entire contents of which are hereby incorporated by reference.

### BACKGROUND

Computer arrangements for providing services to clients over a network typically include several computers, called servers, providing particular services that clients can use by sending appropriate requests over a network. There is a huge variety of different types of services that can be offered by servers, e.g., file-, web- or database-services.

Usually, each individual service is provided by an application program running on a server. Often, many instances of an application are executed in parallel in order to be able to handle all incoming requests. Depending on its capacity and performance, a single server can host just one application program or several instances of one or different application programs. In the following, a situation is assumed, for example, where each server runs only one instance of an application to provide a particular service. However, it is to be understood that the invention is not limited to servers running only one instance of an application.

It is desirable that clients do not have to care about the actual configuration of a computer arrangement that provides a service, i.e., clients do not have to know (or cannot know) which one of the servers are available to process their tasks. This can be achieved by providing a central authority, i.e., a router, that receives incoming requests of clients and distributes (i.e., routes) them to one of the servers. Clients have to know only one address, often called a virtual address, to which they send their request. This virtual address is assigned to the router, which redirects the request to one of the servers by replacing the destination address (i.e., the virtual address) with the address of one of the servers. The servers usually have addresses that are visible just within the computer arrangement. The router is supplied a list of these addresses. If the routing process is set up to equalize the work-load of the servers, this central authority is referred to as a network load balancer. Different types of network load balancers are known, some of which actually measure the load that applications impose on the servers, and some keep track of distributed tasks and either calculate load values or just distribute the requests for all servers having to handle a comparable number of requests at the same time. Furthermore, network load balancers exist that determine and use additional information, for example the state of the servers, i.e., whether each server operates correctly or not.

Often, a network service provider runs a plurality of servers, called a server farm. Considering the growing size of modem server farms, which can consist of hundreds of servers, there is an increasing demand to automate administrative tasks, for example allocating the available resources to different types of services.

The approach to automate administrative tasks is known as autonomous computing (AC). A central element in an AC-environment is an automated administrator for performing administrative tasks, which is sometimes also referred to as a decision engine. The automated administrator is capable of dynamically allocating or freeing servers and of starting new or stopping running instances of different applications on these servers, thereby conditioning the server to provide a particular service. In the following, “provisioning” a server is meant to comprise all necessary administrative steps to prepare or condition a server to be ready to provide a particular service. Usually, the automated administrator is hosted on a computer within the arrangement that is specifically designated for administrative tasks. The decision whether to start or stop instances of applications and whether it is necessary to allocate new servers or give away control over servers depends on a number of criteria and basic conditions. Important factors are, for example, how much load running instances of an application carry and the state of the servers. Also, other, non-technical but economical considerations, for example different priorities of customers, might be taken into account.

In an autonomous computer arrangement that uses one or more network load balancers, the automated administrator as well as the load balancers might need information on the servers and on applications in order to fulfill their duties. Both authorities determine this information, thereby causing extra workload and network traffic.

### SUMMARY

The invention relates to a computer arrangement that includes at least two servers for providing services to clients over a network, involving the use of an automated administrator and a network load balancer within the computer arrangement, where the workload and the network traffic caused by the determination of information needed by the network load balancers and the automated administrator are minimized.

The described computer arrangement comprises: at least two servers, each hosting at least one application and designated to provide the services to clients over the network; an automated administrator configured to provision the servers to provide the services by allocating the servers and/or by starting or stopping instances of the applications on the servers; and at least one network load balancer connected to the clients and the servers, responsible for at least one of the services and configured to gather information on the state of the servers and/or the applications on the servers and set up to route incoming requests of clients to one of the servers. The computer arrangement and the method described herein are characterized in that the network load balancer provides the automated administrator with information on the state of the servers and/or the applications on the servers, and the automated administrator provides the network load balancer with information about which servers are provisioned to provide the at least one service for which the network load balancer is responsible.

According to the invention, information that is needed by both the network load balancer and the automated administrator is shared. This avoids having to obtain relevant information twice and thus decreases workload and network traffic.

In an exemplary embodiment, each server hosts a network load balancer agent, the network load balancer agent being configured to determine information on the state of the servers and/or the applications on the servers and configured to report the information to the network load balancer. In a further exemplary embodiment, the servers are provided with an operating system comprising a kernel, and the network load balancer agents are integrated into the kernel.

The above and still further features and advantages of the computer arrangement and method for providing services to clients over a network will become apparent upon consideration of the following definitions, descriptions and descriptive figures of specific embodiments thereof, wherein like reference numerals in the various figures are utilized to designate like components. While these descriptions go into specific details of the invention, it should be understood that variations may and do exist and would be apparent to those skilled in the art based on the descriptions herein.

### BRIEF DESCRIPTION OF THE DRAWINGS

The computer arrangement and method for providing services to clients over a network is explained in more detail below in conjunction with the accompanying drawings, where:

FIG. 1 is a conceptual diagram of an exemplary embodiment of a computer arrangement according to the present invention;

FIG. 2 is a flowchart representation of an embodiment of a method for providing services to clients over a network according to the present invention.

### DETAILED DESCRIPTION

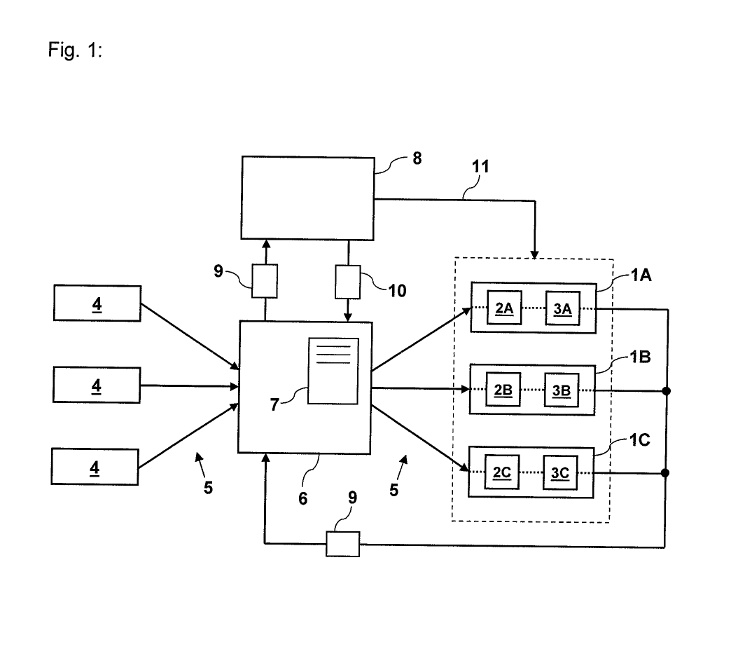

FIG. 1 shows several servers 1 (1A, 1B, 1C), each hosting an application 2 (2A, 2B, 2C) and a network load balancer agent 3 (3A, 3B, 3C). The servers 1 are set up to provide services to clients 4 using a network 5. The computer arrangement further comprises a network load balancer 6 with a list of addresses 7 and an automated administrator 8. The network load balancer 6 is connected to the clients 4 and the servers 1 by the network 5. Furthermore, network load balancer 6 is connected to the network load balancer agents 3 to receive state information 9 and to the automated administrator 8 to transmit the state information 9 to and receive provisioning information 10 from the automated administrator 8. The automated administrator 8 is set up to control the servers 1 using a control connection 11.

FIG. 1 shows a computer arrangement where three servers 1 are configured to provide a particular service made available by instances of the application 2 to the clients 4. In the embodiment shown, each server 1 hosts just one application 2. However, the invention is not restricted to such a situation. Servers 1 could also host several applications 2, possibly in conjunction with different network load balancers 6 for different types of applications 2. Also, the numbers of servers 1 shown in the diagram is just exemplary. Computer arrangements for providing services to clients over a network often comprise several tens or even hundreds of servers. The arrangement might comprise further servers 1 which might be used to provide further services. The invention can be easily applied to computer arrangements (server farms) of any size. The servers 1 can either be independent physical units, for example blade servers, or can be virtual servers. Virtual servers share a common hardware which runs software that emulates several hardware units.

Each service provided by the computer arrangement is related to a particular network address. In order to select a particular service, clients 4 use this particular network address as the destination address in a request to be sent to the computer arrangement. Within the computer arrangement, each network addresses for a particular service is assigned to a central instance, which receives the request and routes it to one of the servers 1. In the embodiment shown, the network load balancer 6 is the central instance that receives all requests of clients 4 concerning the particular service made available by the application 2. For example, the network load balancer 6 is responsible for one particular service only.

The network load balancer 4 redirects an incoming request to one of the servers 1 and thus to an instance of application 2 that actually processes the request. This can for example be achieved by overwriting the destination address of the request with the address of the server 1 to which the request is redirected. After having processed the request, the server 1 then sends its reply directly back to the client 4, the address of which is contained in the request and thus known to the server 1. The server 1 adds the address of the network load balancer 6 as the sender's address to the reply. In that case, a direct network connection between the servers 1 and the client 4 is needed.

In FIG. 1, network 5 is depicted by point-to-point connections between clients 4 and network load balancer 6, and network load balancer 6 and servers 1, respectively, to symbolize the data flow of requests. However, it is to be understood that the underlying network 5 is usually a network that allows data to be exchanged between all participants.

Other known techniques for routing or redirecting requests could as well be used. The reply could, for example, be sent back via the network load balancer 4 who would add its sender's address to the reply itself.

For the network load balancer 6 to be able to distribute the requests to the servers 1, it has to be provided with information about which servers 1 are available for the requested service. This information is kept in the list of addresses 7 of available servers 1.

The decision to which server 1 a new request of one of the clients 4 is directed is based on the operating state of servers 1 and applications 2. An important factor in the decision making process is the load that the applications 2 impose on the servers 1.

Several different techniques of how to: determine, calculate or estimate load values are known. In the embodiment shown network load balancer agents 3 are used. Each server 1 hosts one network load balancer agent 3 which is set up to determine information 9 on the state of the server 1 and the application 2, which is called state information 9 for short. State information 9 that is relevant for the routing decisions of the network load balancer comprises, for example, information whether the server 1 operates correctly or not, whether the application 2 works correctly or not, how busy the application is or how much load it imposes on the server.

An exemplary configuration is to implement the network load balancer agents 3 close to the operating systems of the servers 1 or even integrate them into the kernel of the operating system. Network load balancer agents 3 can then be equipped with wide access privileges which would not be possible if they were implemented in a user accessible operating space where the access privileges would be limited. Kernel-based network load balancer agent 3 have several advantages. A kernel-based network load balancer agent 3 is able to send state information under many circumstances where a user space network load balancer agent 3 could not. For example, if the user space allowed processor load is so high that processes cannot run, a kernel-based network load balancer agent 3 will still be able to operate. Likewise, a kernel-based network load balancer agent 3 can observe function- and/or subroutine-calls from application 2 to the operating system. The kernel-based network load balancer agent 3 can, for example, observe if the application is still listening to a network interface (e.g., a port monitored by the application 2) by detecting the “listen” call to the operating system's kernel, thereby judging whether the application is still operating or not. This approach is faster and generates less additional workload than repeatedly sending check requests to the monitored port. Finally, the kernel-based network load balancer agent 3 detects and responds to events faster than a user space network load balancer agent 3.

The state information 9 determined by the network load balancer agent 3 is then sent to the network load balancer 6 and is used in the decision making process to which server 1 requests are routed. For the transmission of the state information 9, a separate network could be used for security and/or performance reasons, or the same network 5 that connects the servers 1, the clients 4 and the network load balancer 6 could be used. Preferably, the information 9 is encapsulated in a mark-up language, e.g., XML (eXtensible Markup Language), for transmission.

Providing services that have a fast response time on the one hand, and that do not waste any server capacity on the other hand, requires that an appropriate number of instances of an application 2 are running and, therefore, that an appropriate number of servers 1 are dedicated to host these instances.

Provisioning the servers 1 by allocating them and/or by starting instances of a particular application 2 is performed by the automated administrator 8. The automated administrator 8 may be software-implemented and hosted on a separate computer. For reasons of high availability and redundancy there may also be second automated administrator that could take over in case of a failure of the first automated administrator 8.

Different methods to provision servers 1 by the automated administrator 8 are known. One way is to remotely start or stop instances of an application depending on requirements. This bears the danger of collecting remains of all applications that were once started and stopped again (like temporary files) which might lead to an unstable and slow system. Therefore, often another approach, sometimes called “bare-metal provisioning,” is chosen, where for each new task (different customer, different applications) a whole boot image is transferred to a server and the server is re-booted with the new boot image. In the following “provisioning” a server 1 for a particular service is meant to comprise all methods that prepare or condition a server 1 to be available for providing a particular service.

The control connection 11 between the automated administrator 8 and the servers 1 which is used to provision the servers 1 could be established through the network 5. In another embodiment, a separate network could be used for security and/or performance reasons.

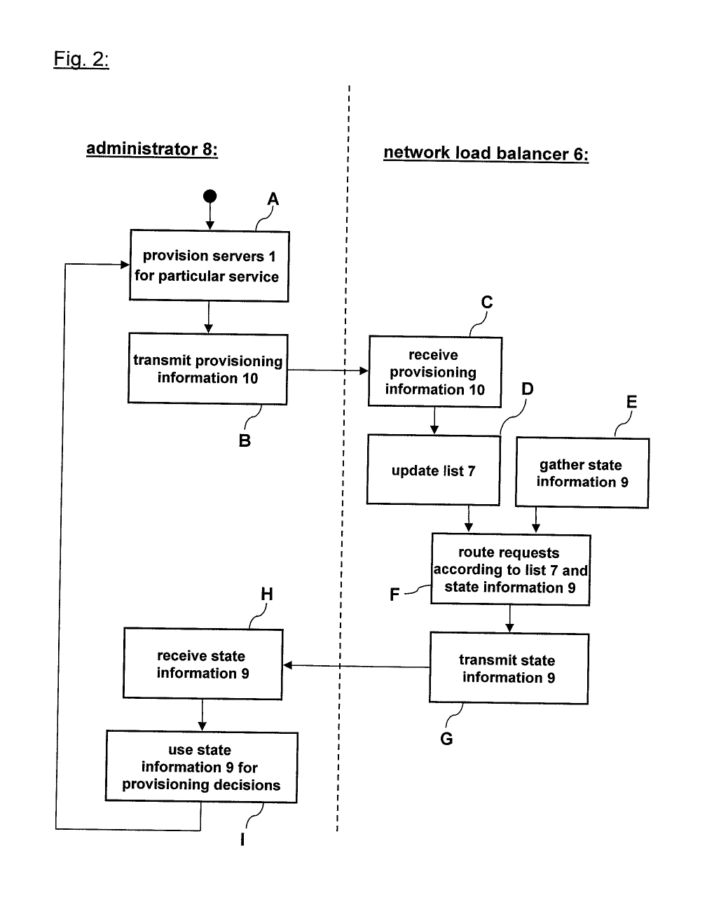

A basic idea behind the invention is that in an autonomous computing environment the performance of the system can be enhanced when automated administrator 8 and network load balancer 6 share their information on the servers 1. The resulting exchange of information is now described in conjunction with FIG. 2.

FIG. 2 shows a flowchart representation of an embodiment of a method for providing services to clients over a network.

In step A of FIG. 2, a provisioning decision concerning a particular service is translated into action by the automated administrator 8 using the control line 11 as described above in connection with FIG. 1. If the particular service is to be started for the first time, the provisioning decision is based on predetermined initialization values or might be initialized.

Information 10 on the provisioning process, called provisioning information 10 for short) is then transmitted from the automated administrator 8 to the network load balancer 6 in step B. Provisioning information 10 comprises at least the network addresses of the servers 1 that are provisioned to provide the particular service the network load balancer is responsible for or that are deprovisioned, i.e., either added to or removed from the pool of servers 1 conditioned to provide that particular service. Additional data that might be relevant for the routing process and could be used by the network load balancer 6 could also be contained in provisioning information 10. Such additional data could for example be data on the performance of provisioned servers 1. Provisioning information 10 could be in form a mark-up language based transaction, in particular in form of an XML-based transaction.

In step C, the provisioning information 10 is received by the network load balancer 6 and used to update the list 7 in step D. Instead of a list, any appropriate data structure could be used.

In step E, state information 9 on the servers 1 and the application 2 on these servers 1 are gathered from the network load balancer agent 3. State information 9 is then used to decide to which server 1 contained in the list 7 a request of a client is routed to as shown in step F.

State information 9 is transmitted to and received by the automated administrator 8 in steps G and H, respectively. The state information 9 transmitted to the automated administrator 8 might not be in exactly the same form and format as it was originally received by the network load balancer 6. Instead, it could be a selected subset of the originally received state information 9 or the originally received state information 9 could be processed by the network load balancer 6 before transmission. Processing could for example involve time averaging, especially in case of fluctuating load data.

In step I, the state information 9 is used by the automated administrator to make further provisioning decisions, if appropriate. The method then restarts with step A to translate any further provisioning decisions into action.

The method leads to an iterative and interactive decision making process based on the state information 9 and the provisioning information 10 exchanged between automated administrator 8 and network load balancer 6.

While the invention has been described in detail with reference to specific embodiments thereof, it will be apparent to one of ordinary skill in the art that various changes and modifications can be made therein without departing from the spirit and scope thereof. Accordingly, it is intended that the present invention covers the modifications and variations of this invention provided they come within the scope of the appended claims and their equivalents.

What is claimed is:

1. A computer arrangement for providing services for clients over a network, comprising:
a plurality of servers, each server hosting at least one application and being configured to provide at least one service to at least one client over the network;
an automated administrator configured to provision the servers to provide services by allocating the servers or by starting or stopping instances of applications on the servers; and
at least one network load balancer connected to the clients and the servers and responsible for at least one service, the network load balancer being configured to gather state information regarding the state of the servers or the applications on the servers, and being configured to route incoming requests of clients to at least one of the servers;
wherein the network load balancer provides the automated administrator with the state information of the servers or the applications on the servers; and
wherein the automated administrator provides the network load balancer with provisioning information regarding which servers are provisioned to provide the at least one service for which the network load balancer is responsible.

2. The computer arrangement of claim 1, wherein the provisioning information comprises a list of the respective servers.

3. The computer arrangement of claim 1, wherein each server hosts a network load balancer agent configured to determine the state information and to report the state information to the network load balancer.

4. The computer arrangement of claim 3, wherein the servers are provided with an operating system including a kernel comprising the network load balancer agents.

5. The computer arrangement of claim 4, wherein the network load balancer agents determine the state information regarding the state of applications on the servers by observing at least one of: function and subroutine calls of the applications to the operating system.

6. The computer arrangement of claim 3, wherein the state information sent from the network load balancer agents to the network load balancer is transmitted in a mark-up language.

7. The computer arrangement of claim 1, wherein the state and provisioning information exchanged between the network load balancer and the automated administrator is transmitted in a mark-up language.

8. A method for providing services for clients over a network, the method comprising:
providing a computer arrangement including:
a plurality of servers, each server hosting at least one application and being configured to provide the services to clients over the network;
an automated administrator configured to provision the servers to provide the services by allocating the servers or by starting or stopping instances of the applications on the servers;
at least one network load balancer responsible for at least one of the services, the network load balancer being configured to gather state information regarding the state of the servers or the applications and to route incoming requests of clients to at least one of the servers based on the state information;
transmitting state information, regarding the state of the servers or the applications on the servers, from the network load balancer to the automated administrator;
selectively provisioning at least one of the servers by the automated administrator based on the state information; and
transmitting provisioning information, regarding which servers are provisioned to provide the at least one service for which the network load balancer is responsible, from the automated administrator to the network load balancer.
